(19) United States
(12) Patent Application Publication
(10) Pub. No.: US 2020/0403253 A1
(43) Pub. Date: Dec. 24, 2020

(54) FUEL CELL STACK

(71) Applicant: HONDA MOTOR CO., LTD., Tokyo (JP)

(72) Inventors: Kentaro ISHIDA, WAKO-SHI (JP); Hiroyuki TANAKA, TORRANCE, CA (US); Masaaki SAKANO, WAKO-SHI (JP)

(21) Appl. No.: 16/447,290

(22) Filed: Jun. 20, 2019

(51) Int. Cl. H01M 8/0284; H01M 8/0206; H01M 8/0228; H01M 8/2465; H01M 8/0258; H01M 8/0267; H01M 8/1004; H01M 8/0297

(52) U.S. Cl. CPC H01M 8/0284; H01M 8/0206; H01M 8/0228; H01M 8/0297; H01M 8/0258; H01M 8/0267; H01M 8/1004; H01M 8/2465

(57) ABSTRACT

In a fuel cell stack, an electrically insulating frame shaped resin film having a constant thickness is provided on an outer peripheral side of a power generation surface of an MEA. An outer peripheral end of the resin film protrudes outside of a first outer peripheral end of a first metal separator and a second outer peripheral end of a second metal separator over the entire periphery.

### BACKGROUND OF THE INVENTION

### Field of the Invention

The present invention relates to a fuel cell stack.

### Description of the Related Art

The fuel cell stack includes a cell stack body formed by stacking a plurality of power generation cells. Each of the power generation cells includes a membrane electrode assembly and a pair of metal separators provided on both sides of the membrane electrode assembly. The membrane electrode assembly includes an electrolyte membrane and electrodes provided on both sides of the electrolyte membrane (for example, see Japanese Laid-Open Patent Publication No. 2019-003840). Fluid passages are formed in the cell stack body for allowing reactant gases to flow in a stacking direction.

### SUMMARY OF THE INVENTION

In the above fuel cell stack, if water condensation occurs in an outer peripheral portion of the power generation cell, or if electrically conductive substance is adhered to the outer peripheral portion of the power generation cell, the pair of metal separators provided on both sides of the membrane electrode assembly may be connected together electrically. Further, when water produced in electrochemical reactions of the power generation cells flows into the fluid passages, the pair of metal separators provided on both sides of the membrane electrode assembly may be connected together electrically. Under the circumstances, corrosion of the metal separators may occur.

The present invention has been made taking such problems into consideration, and an object of the present invention is to provide a fuel cell stack which makes it possible to prevent corrosion of metal separators.

According to a first aspect of the present invention, there is provided a fuel cell stack including a cell stack body including a plurality of stacked power generation cells, the power generation cells each including a membrane electrode assembly and a pair of metal separators provided on both sides of the membrane electrode assembly, the membrane electrode assembly including an electrolyte membrane, and electrodes provided on both sides of the electrolyte membrane, wherein an electrically insulating frame shaped outer film having a substantially constant thickness is provided on an outer peripheral side of a power generation surface of the membrane electrode assembly, and an outer peripheral end of the outer film protrudes outside of outer peripheral ends of the pair of metal separators over entire periphery.

According to a second aspect of the present invention, there is provided a fuel cell stack including a cell stack body including a plurality of stacked power generation cells, the power generation cells each including a membrane electrode assembly and a pair of metal separators provided on both sides of the membrane electrode assembly, the membrane electrode assembly including an electrolyte membrane, and electrodes provided on both sides of the electrolyte membrane, wherein an electrically insulating frame shaped outer film having a substantially constant thickness is provided on an outer peripheral side of a power generation surface of the membrane electrode assembly, and a reactant gas passage is formed in each of the pair of metal separators and the outer film, for allowing a reactant gas to flow in a stacking direction of the cell stack body, and a hole forming edge of the outer film around the reactant gas passage protrudes inside of inner ends of hole forming edges of the pair of metal separators around the reactant gas passage.

In the first aspect of the present invention, the outer peripheral end of the outer film protrudes outside of the outer peripheral ends of the pair of metal separators over the entire periphery. In the structure, even in the case where water condensation occurs in (electrically conductive substance is adhered to) the outer peripheral ends of the pair of metal separators, it is possible to prevent these metal separators from being connected together electrically through water droplets (condensed water) or the electrically conductive member, by the outer peripheral end of the outer film. Therefore, it is possible to prevent corrosion of the metal separators.

In the second aspect of the present invention, the hole forming edge of the outer film around the reactant gas passage protrudes inside of the inner ends of hole forming edges of the pair of metal separators around the reactant gas passage. In the structure, even in the case where the water produced during power generation flows into the reactant gas passage, it is possible to prevent the pair of metal separators from being connected together electrically through the produced water, by the hole forming edge of the outer film.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view showing a fuel cell stack according to an embodiment of the present invention;

FIG. 2 is a vertical cross sectional view with partial omission, showing the fuel cell stack in FIG. 1;

FIG. 3 is an exploded perspective view showing a power generation cell in FIG. 1;

FIG. 4 is a plan view showing a first metal separator in FIG. 3 as viewed from a side where an electrolyte membrane is present;

FIG. 5 is a lateral cross sectional view showing the fuel cell stack in FIG. 1;

FIG. 6 is a cross sectional view with partial omission taken along a line VI-VI in FIG. 5; and

FIG. 7 is a cross sectional view with partial omission showing a cell stack body including a first metal separator and a second metal separator according to a modified embodiment.

### DESCRIPTION OF THE PREFERRED EMBODIMENTS

Hereinafter, preferred embodiments of a fuel cell stack according to the present invention will be described with reference to the accompanying drawings.

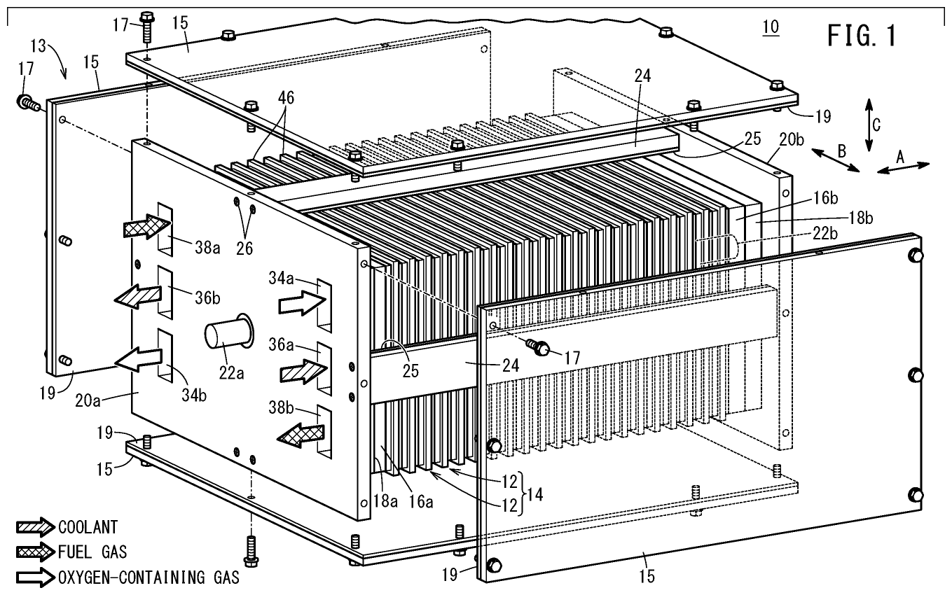

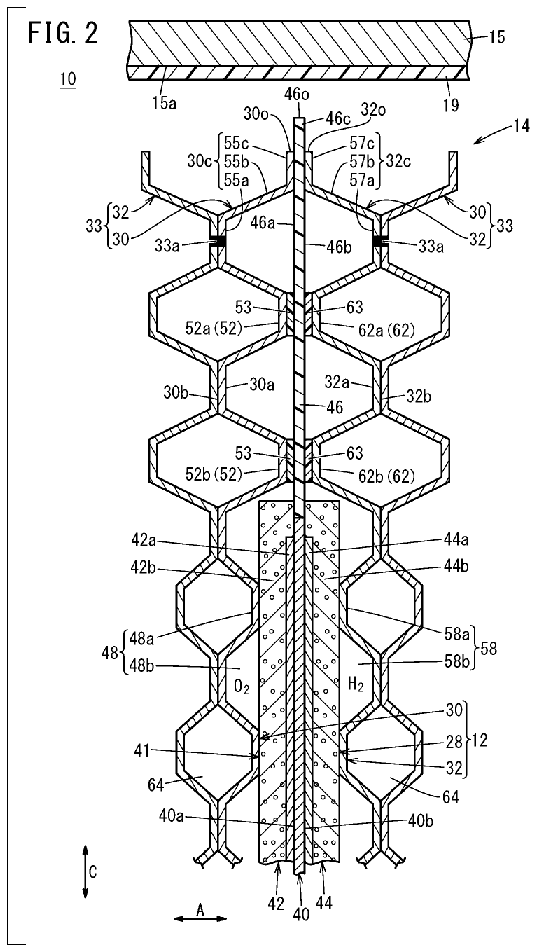

As shown in FIGS. 1 and 2, a fuel cell stack 10 according to the present invention includes a cell stack body 14 formed by stacking a plurality of power generation cells 12 in a horizontal direction (indicated by an arrow A). It should be noted that the cell stack body 14 may be formed by stacking a plurality of power generation cells 12 in the gravity direction (indicated by an arrow C). For example, the fuel cell stack 10 is mounted in a fuel cell vehicle such as a fuel cell electric automobile (not shown).

In FIG. 1, at one end of the cell stack body 14 in the direction indicated by the arrow A, a terminal plate 16a is provided. An insulator 18a is provided outside the terminal plate 16a, and an end plate 20a is provided outside the insulator 18a. At the other end of the cell stack body 14 in the stacking direction, a terminal plate 16b is provided. An insulator 18b is provided outside the terminal plate 16b, and an end plate 20b is provided outside the insulator 18b. Terminal units 22a, 22b are provided in the terminal plates 16a, 16b, respectively. The terminal units 22a, 22b protrude outward in the stacking direction.

Each of the end plates 20a, 20b has a laterally elongated (or longitudinally elongated) rectangular shape. Coupling bars 24 are positioned between the sides of the end plates 20a, 20b. Both ends of the coupling bars 24 are fixed to inner surfaces of the end plates 20a, 20b through bolts 26 to apply a tightening load to the plurality of stacked power generation cells 12 in the stacking direction indicated by the arrow A.

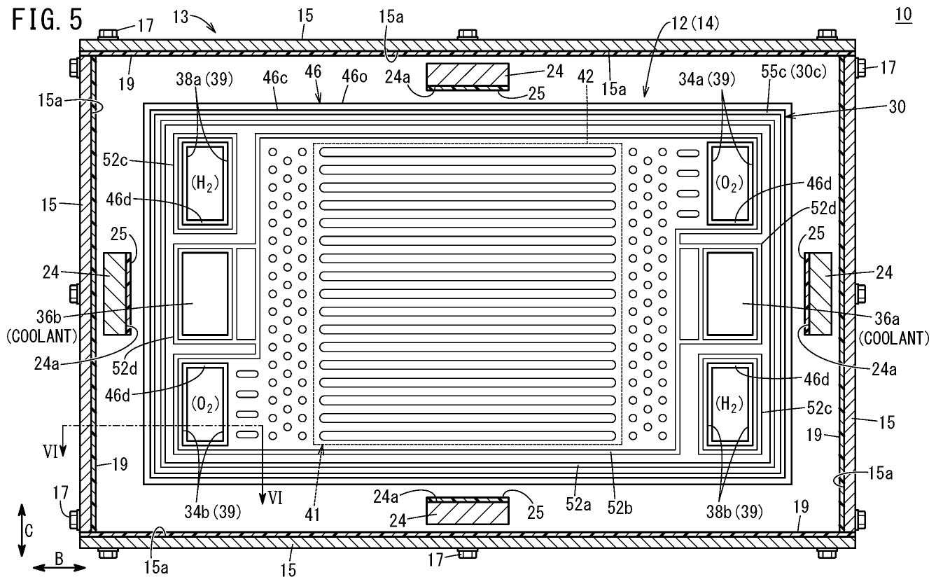

In FIGS. 1 and 5, an electrically insulating layer 25 (resin layer) is formed on an inner surface 24a (surface facing the cell stack body 14) of each of the coupling bars 24. For example, the insulating layer 25 is made of the same material as a resin film 46 described later.

The fuel cell stack 10 includes a case 13 containing a cell stack body 14. The case 13 includes two end plates 20a, 20b, and four side panels 15 covering the cell stack body 14 from a direction perpendicular to the stacking direction. The end plates 20a, 20b also serve as end plates of the case 13. The side panels 15 are fixed to side surfaces of the end plate 20a, 20b using bolts 17.

An electrically insulating layer 19 (resin layer) is formed on an inner surface 15a (surface facing the cell stack body 14) of the side panel 15. For example, the insulating layer 19 may be made of the same material as the resin film 46 described later. It should be noted that the case 13 may include two end plates 20a, 20b and a side cover formed to have a rectangular cylindrical shape by extrusion. In this case, the insulating layer 19 is formed on an inner peripheral surface of the side cover.

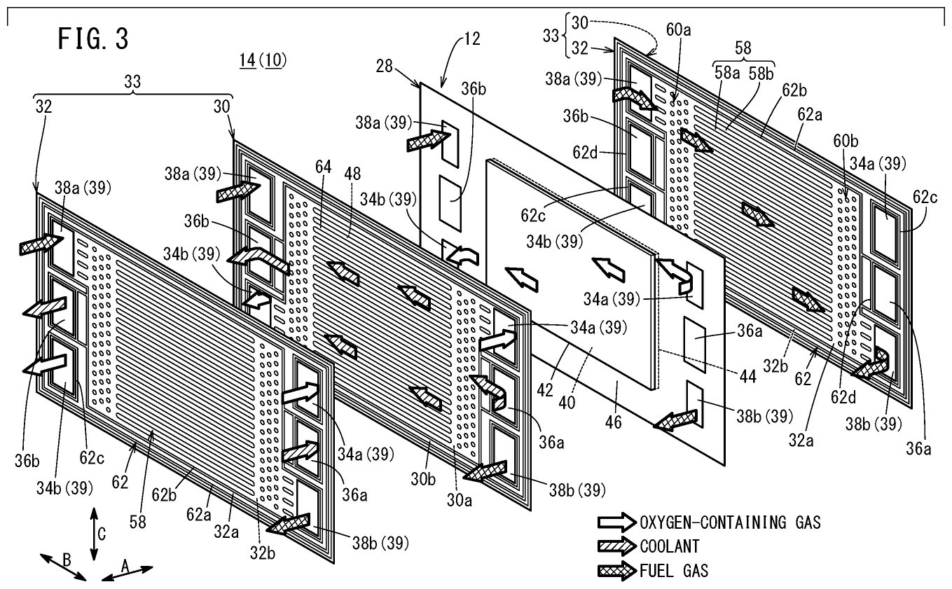

As shown in FIGS. 2 and 3, the power generation cell 12 is formed by sandwiching a membrane electrode assembly (hereinafter also referred to as the “MEA 28”) between a first metal separator 30 and a second metal separator 32. Each of the first metal separator 30 and the second metal separator 32 is formed by press forming of a metal thin plate to have a corrugated shape in cross section. For example, the metal plate is a steel plate, a stainless steel plate, an aluminum plate, a plated steel plate, or a metal plate having an anti-corrosive surface by surface treatment.

Outer ends of the first metal separator 30 and the second metal separator 32 are joined together by welding, brazing, crimpling, etc. to form a joint separator 33.

In FIG. 3, at one end of the power generation cell 12 in a long side direction indicated by an arrow B (horizontal direction), an oxygen-containing gas supply passage 34a, a coolant supply passage 36a, and a fuel gas discharge passage 38b are arranged in the direction indicated by the arrow C. The oxygen-containing gas supply passage 34a extends through each of the power generation cells 12 in the stacking direction (indicated by the arrow A) for supplying the oxygen-containing gas. The coolant supply passage 36a extends through each of the power generation cells 12 in the stacking direction for supplying pure water, ethylene glycol, oil, etc. The fuel gas discharge passage 38b extends through each of the power generation cells 12 for discharging the fuel gas such as a hydrogen-containing gas.

At the other end of the power generation cell 12 in the direction indicated by the arrow B, a fuel gas supply passage 38a, a coolant discharge passage 36b, and an oxygen-containing gas discharge passage 34b are arranged in the direction indicated by the arrow C. The fuel gas supply passage 38a extends through each of the power generation cells 12 in the stacking direction for supplying a fuel gas. The coolant discharge passage 36b extends through each of the power generation cells 12 in the stacking direction for discharging the coolant. The oxygen-containing gas discharge passage 34b extends through each of the power generation cells 12 in the stacking direction for discharging the oxygen-containing gas.

The layout, the shapes, and the sizes of the oxygen-containing gas supply passage 34a, the oxygen-containing gas discharge passage 34b, the fuel gas supply passage 38a, and the fuel gas discharge passage 38b are not limited to the above embodiment, and may be changed depending on the required specification.

As shown in FIGS. 2 and 3, the MEA 28 includes an electrolyte membrane 40, a cathode 42 and an anode 44 provided on both sides of the electrolyte membrane 40, and the resin film 46 (outer film part) provided along the outer periphery of the electrolyte membrane 40. For example, the electrolyte membrane 40 includes a solid polymer electrolyte membrane (cation ion exchange membrane). For example, the solid polymer electrolyte membrane is a thin membrane of perfluorosulfonic acid containing water. A fluorine based electrolyte may be used as the electrolyte membrane 40. Alternatively, an HC (hydrocarbon) based electrolyte may be used as the electrolyte membrane 40. The surface size (outer size) of the electrolyte membrane 40 is smaller than the surface sizes (outer sizes) of the cathode 42 and the anode 44. The electrolyte membrane 40 includes an overlapped part which is overlapped with an outer peripheral portion of the cathode 42 and the other peripheral portion of the anode 44.

In FIG. 2, the cathode 42 includes a first electrode catalyst layer 42a joined to one surface 40a of the electrolyte membrane 40, and a first gas diffusion layer 42b stacked on the first electrode catalyst layer 42a. The outer size of the first electrode catalyst layer 42a is smaller than the outer size of the first gas diffusion layer 42b, and the same as (or less than) the outer size of the electrolyte membrane 40. It should be noted that the outer size of the first electrode catalyst layer 42a may be the same as the outer size of the first gas diffusion layer 42b. The anode 44 includes a second electrode catalyst layer 44a joined to a surface 40b of the electrolyte membrane 40, and a second gas diffusion layer 44b stacked on the second electrode catalyst layer 44a. The outer size of the second electrode catalyst layer 44a is smaller than the outer size of the second gas diffusion layer 44b, and the same as (or less than) the outer size of the electrolyte membrane 40. It should be noted that the outer size of the second electrode catalyst layer 44a may be the same as the outer size of the second gas diffusion layer 44b.

The first electrode catalyst layer 42a is formed by depositing porous carbon particles uniformly on the surface of the first gas diffusion layer 42b, and platinum alloy is supported on surfaces of the carbon particles. The second electrode catalyst layer 44a is formed by depositing porous carbon particles uniformly on the surface of the second gas diffusion layer 44b, and platinum alloy is supported on surfaces of the carbon particles. Each of the first gas diffusion layer 42b and the second gas diffusion layer 44b comprises a carbon paper, a carbon cloth, etc.

The resin film 46 having a frame shape is sandwiched between an outer marginal portion of the first gas diffusion layer 42b and an outer marginal portion of the second gas diffusion layer 44b. An inner end surface of the resin firm 46 is positioned close to, or contacts an outer end surface of the electrolyte membrane 40. As shown in FIG. 3, the oxygen-containing gas supply passage 34a, the coolant supply passage 36a, and the fuel gas discharge passage 38b are provided at one end of the resin film 46 in the direction indicated by the arrow B. The fuel gas supply passage 38a, the coolant discharge passage 36b, and the oxygen-containing gas discharge passage 34b are provided at the other end of the resin film 46 in the direction indicated by the arrow B.

For example, the resin film 46 is made of PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin. It should be noted that the electrolyte membrane 40 may protrude outward without using the resin film 46. In this case, the portion of the electrolyte membrane 40 which protrudes outward from the first metal separator 30 and the second metal separator 32 form the outer film. Further, frame shaped films may be provided on both sides of the electrolyte membrane 40 which protrudes outward.

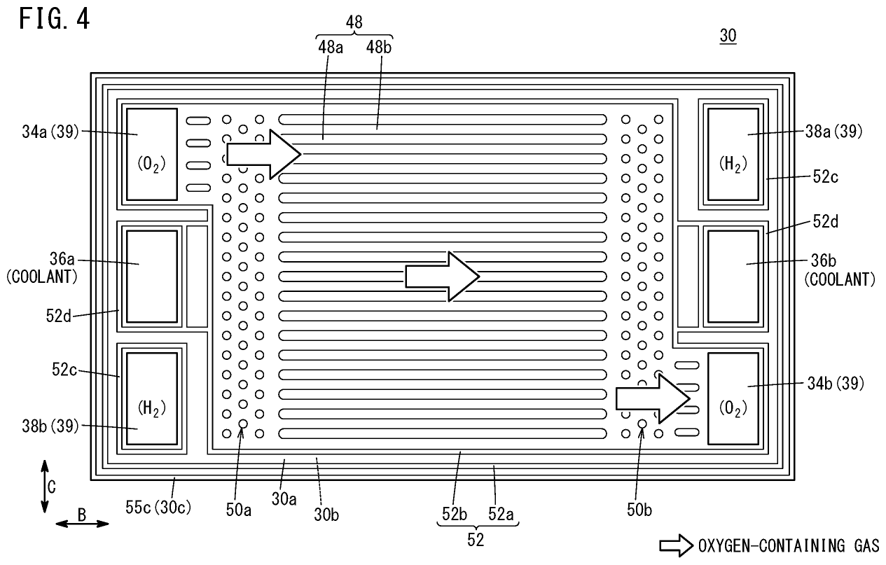

As shown in FIGS. 3 and 4, the first metal separator 30 has an oxygen-containing gas flow field 48 on its surface 30a facing the resin film equipped MEA 28. For example, the oxygen-containing gas flow field 48 extends in the direction indicated by the arrow B. The oxygen-containing gas flow field 48 is connected to (in fluid communication with) the oxygen-containing gas supply passage 34a and the oxygen-containing gas discharge passage 34b. The oxygen-containing gas flow field 48 includes straight flow grooves 48b (or wavy flow grooves) between a plurality of ridges 48a extending in the direction indicated by the arrow B.

An inlet buffer 50a having a plurality of bosses is provided between the oxygen-containing gas supply passage 34a and the oxygen-containing gas flow field 48. An outlet buffer 50b having a plurality of bosses is provided between the oxygen-containing gas discharge passage 34b and the oxygen-containing gas flow field 48.

In FIG. 4, a first seal bead 52 is formed on the surface 30a of the first metal separator 30. The first seal bead 52 includes an outer bead 52a formed around the outer marginal portion of the surface 30a of the first metal separator 30. The outer bead 52a prevents leakage of fluid (the oxygen-containing gas, the fuel gas, and the coolant) from a space between the MEA 28 and the first metal separator 30 to the outside.

The first seal bead 52 includes an inner bead 52b formed around the oxygen-containing gas flow field 48, the oxygen-containing gas supply passage 34a, and the oxygen-containing gas discharge passage 34b, while allowing the oxygen-containing gas flow field 48 to be connected to the oxygen-containing gas supply passage 34a and the oxygen-containing gas discharge passage 34b. The inner bead 52b prevents leakage of the oxygen-containing gas from the oxygen-containing gas flow field 48 to the outside.

The first seal bead 52 includes passage beads 52c formed around the fuel gas supply passage 38a and the fuel gas discharge passage 38b, respectively, and passage beads 52d formed around the coolant supply passage 36a and the coolant discharge passage 36b, respectively. The passage beads 52c prevent leakage of the fuel gas from the fuel gas supply passage 38a and the fuel gas discharge passage 38b to the outside. The passage beads 52d prevent leakage of the coolant from the coolant supply passage 36a and the coolant discharge passage 36b to the outside. The outer bead 52a may be provided as necessary. The outer bead 52a may be dispensed with.

As shown in FIG. 2, the first seal bead 52 is formed by press forming, and expanded from the surface 30a of the first metal separator 30. That is, the first seal bead 52 protrudes from the surface 30a of the first metal separator 30 in the stacking direction (toward the resin film 46 of the MEA 28).

An elastic resin member (rubber seal) 53 is provided on a protruding end surface of the first seal bead 52. The resin member 53 contacts one surface 46a of the resin film 46. It should be noted that, instead of the first seal bead 52, an elastic rubber seal may be provided integrally with, or separately from the first metal separator 30. In this case, a first outer peripheral end 30c of the first metal separator 30 is not covered with the rubber seal, and is exposed.

As shown in FIG. 3, the second metal separator 32 has a fuel gas flow field 58 on its surface 32a facing the MEA 28. For example, the fuel gas flow field 58 extends in the direction indicated by the arrow B. The fuel gas flow field 58 is connected to (in fluid communication with) the fuel gas supply passage 38a and the fuel gas discharge passage 38b. The fuel gas flow field 58 includes straight flow grooves 58b (or wavy flow grooves) between a plurality of ridges 58a extending in the direction indicated by the arrow B.

An inlet buffer 60a having a plurality of bosses is provided between the fuel gas supply passage 38a and the fuel gas flow field 58. An outlet buffer 60b having a plurality of bosses is provided between the fuel gas discharge passage 38b and the fuel gas flow field 58.

A second seal bead 62 is provided on the surface 32a of the second metal separator 32. The second seal bead 62 includes an outer bead 62a formed around the outer marginal portion of the surface 32a of the second metal separator 32. The outer bead 62a prevents leakage of fluid (the oxygen-containing gas, the fuel gas, and the coolant) from a space between the MEA 28 and the second metal separator 32 to the outside.

The second seal bead 62 includes an inner bead 62b formed around the fuel gas flow field 58, the fuel gas supply passage 38a, the fuel gas discharge passage 38b, while allowing the fuel gas flow field 58 to be connected to the fuel gas supply passage 38a and the fuel gas discharge passage 38b. The inner bead 62b prevents leakage of the fuel gas from the fuel gas flow field 58 to the outside.

The second seal bead 62 includes passage beads 62c formed around the oxygen-containing gas supply passage 34a and the oxygen-containing gas discharge passage 34b, respectively, and passage beads 62d formed around the coolant supply passage 36a and the coolant discharge passage 36b, respectively. The passage beads 62c prevent leakage of the oxygen-containing gas from the oxygen-containing gas supply passage 34a and the oxygen-containing gas discharge passage 34b to the outside. The passage beads 62d prevent leakage of the coolant from the coolant supply passage 36a and the coolant discharge passage 36b to the outside. It should be noted that the outer bead 62a may be provided as necessary. The outer bead 62a may be dispensed with.

As shown in FIG. 2, the second seal bead 62 is formed by press forming, and expanded from the surface 32a of the second metal separator 32. That is, the second seal bead 62 protrudes from the surface 32a of the second metal separator 32 in the stacking direction (toward the resin film 46 of the MEA 28).

An elastic resin member (rubber seal) 63 is provided on a protruding end surface of the second seal bead 62. The resin member 63 contacts another surface 46b of the resin film 46. It should be noted that, instead of the second seal bead 62, an elastic rubber seal may be provided integrally with, or separately from the second metal separator 32. In this case, a second outer peripheral end 32c of the second metal separator 32 is not covered with the rubber seal, and is exposed.

In FIG. 3, a coolant flow field 64 is formed between a surface 30b of the first metal separator 30 and a surface 32b of the second metal separator 32 that are joined together. The coolant flow field 64 is connected to (in fluid communication with) the coolant supply passage 36a and the coolant discharge passage 36b. The coolant flow field 64 is formed between the back surface of the oxygen-containing gas flow field 48 of the first metal separator 30 and the back surface of the fuel gas flow field 58 of the second metal separator 32, when the first metal separator 30 and the second metal separator 32 are stacked with each other.

Next, in the fuel cell stack 10, structure of the resin film 46, the first metal separator 30, and the second metal separator 32 will be described more in detail below.

As shown in FIGS. 2, 5, and 6, the resin film 46 is provided on the outer peripheral side of the power generation surface 41 of the MEA 28. The resin film 46 is a frame shaped outer film having a substantially constant thickness D1 in its entirety. An outer peripheral end 46c of the resin film 46 protrudes outside of a first outer peripheral end 30o (outer peripheral end surface) of the first metal separator 30 and a second outer peripheral end 32o (outer peripheral end surface) of the second metal separator 32 over the entire periphery. That is, portion (outer peripheral end 46c) of the resin film 46 protruding outside of the first metal separator 30 and the second metal separator 32 extends in a rectangular ring shape. Stated otherwise, the outer shape of the resin film 46 is slightly larger than the outer shapes of the first metal separator 30 and the second metal separator 32.

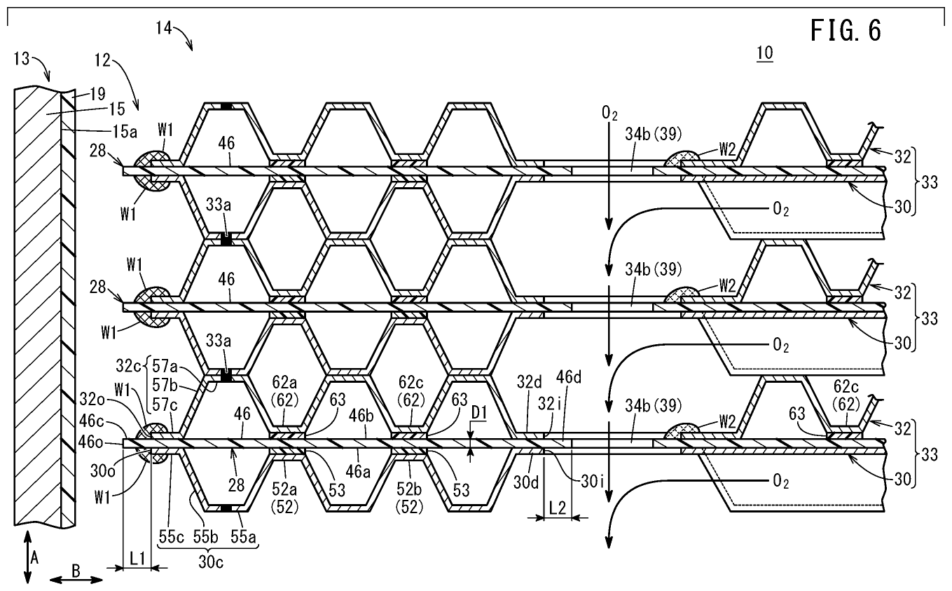

In FIG. 6, the first protruding length L1 by which the resin film 46 protrudes from the first metal separator 30 and the second metal separator 32 is substantially constant over the entire periphery of the resin film 46. The resin film 46 protrudes from the first metal separator 30 and the second metal separator 32 by the same first protruding length L1 in all of the power generation cells 12.

For example, preferably, the first protruding length L1 is 0.2 mm or more but 1.5 mm or less, and more preferably, 0.8 mm or more but 1.5 mm or less. If the first protruding length L1 is 0.2 mm or more, even in the case where water condensation occurs in the first outer peripheral end 30c of the first metal separator 30 and the second outer peripheral end 32c of the second metal separator 32, it is possible to effectively suppress electrical connection between the first metal separator 30 and the second metal separator 32 through water droplets W1 (condensed water). If the first protruding length L1 is 1.5 mm or less, it is possible to reduce the size of the fuel cell stack 10. It should be noted that the first protruding length L1 of the resin film 46 can be determined as necessary.

In FIGS. 2, 5, and 6, an outer peripheral end 46o (outer peripheral end surface) of the resin film 46 is spaced from the insulating layer 25 formed on the inner surface 24a of the coupling bar 24 and the insulating layer 19 formed on the inner surface 15a of the side panel 15. For the purpose of convenience, the space between the outer peripheral end 46o of the resin film 46 and the insulating layer 19 drawn in FIGS. 2 and 6, is shorter than those in FIG. 5. It should be noted that the space between the outer peripheral end 46o of the resin film 46 and the insulating layers 19, 25 can be determined as necessary.

As shown in FIGS. 2 and 6, the resin film 46 is held between the first outer peripheral end 30c of the first metal separator 30 and the second outer peripheral end 32c of the second metal separator 32 over the entire periphery. The first outer peripheral end 30c contacts the one surface 46a of the resin film 46 and the second outer peripheral end 32c contacts the other surface 46b of the resin film 46.

The resin film 46 is held between the outer bead 52a of the first metal separator 30 and the outer bead 62a of the second metal separator 32. In this case, the first outer peripheral end 30c and the second outer peripheral end 32c do not positively receive the tightening load. It should be noted that a minute gap may be formed between the first outer peripheral end 30c and the one surface 46a of the resin film 46, and a minute gap may be formed between the second outer peripheral end 32c and the other surface 46b of the resin film 46 so as not to receive the tightening load by the first outer peripheral end 30c and the second outer peripheral end 32c.

The first outer peripheral end 30c includes a first part 55a extending outward from a root of the outer bead 52a in the direction indicated by the arrow C, a second part 55b extending from an extension end of the first part 55a toward the resin film 46, and a third part 55c extending outward from an extension end of the second part 55b in the direction indicated by the arrow C. The third part 55c is in contact with, or positioned close to one surface 46a of the resin film 46.

The second outer peripheral end 32c includes a first part 57a extending outward from a root of the outer bead 62a in the direction indicated by the arrow C, a second part 57b extending from an extension end of the first part 57a toward the resin film 46, and a third part 57c extending outward from an extension end of the second part 57b in the direction indicated by the arrow C. The third part 57c is in contact with, or positioned close to the other surface 46b of the resin film 46. The first part 55a of the first outer peripheral end 30c and the first part 57a of the second outer peripheral end 32c are joined together by a joint bead 33a (welding bead).

A cutout may be formed in the outer peripheral end 46c of the resin film 46 for providing the coupling bar 24 (see FIG. 5). In this case, the insulating layer 25 is provided not only on the inner surface 24a of the coupling bar 24, but also on both side surfaces of the coupling bar 24, and the outer peripheral end 46c of the resin film 46 is spaced from the coupling bar 24.

As shown in FIGS. 5 and 6, a hole forming edge 46d of the resin film 46 around the oxygen-containing gas discharge passage 34b protrudes inside of a first inner end 30i of a first hole forming edge 30d of the first metal separator 30 around the oxygen-containing gas discharge passage 34b over the entire periphery. That is, as viewed in the stacking direction of the cell stack body 14 (in the direction indicated by the arrow A), the oxygen-containing gas discharge passage 34b formed in the resin film 46 is slightly smaller than the oxygen-containing gas discharge passage 34b formed in the first metal separator 30 (see FIG. 5). The second protruding length L2 by which the hole forming edge 46d of the resin film 46 protrudes from the first inner end 30i of the first metal separator 30 is the same as the first protruding length L1 mentioned above. It should be noted that the second protruding length L2 may be shorter than, or longer than the first protruding length L1.

A hole forming edge 46d of the resin film 46 around the oxygen-containing gas discharge passage 34b protrudes inside of a second inner end 32i of a second hole forming edge 32d of the second metal separator 32 around the oxygen-containing gas discharge passage 34b over the entire periphery. That is, as viewed in the stacking direction of the cell stack body 14 (in the direction indicated by the arrow A), the oxygen-containing gas discharge passage 34b formed in the resin film 46 is slightly smaller than the oxygen-containing gas discharge passage 34b formed in the second metal separator 32. It should be noted that the size and shape of the oxygen-containing gas discharge passage 34b formed in the second metal separator 32 are the same as the size and shape of the oxygen-containing gas discharge passage 34b formed in the first metal separator 30.

In FIG. 6, the resin film 46 is held between the first hole forming edge 30d of the first metal separator 30 and the second hole forming edge 32d of the second metal separator 32. The first hole forming edge 30d contacts one surface 46a of the resin film 46, and the second hole forming edge 32d contacts the other surface 46b of the resin film 46. The resin film 46 is held between the inner bead 52b of the first metal separator 30 and the passage bead 62c of the second metal separator 32, around the oxygen-containing gas discharge passage 34b. In this case, the first hole forming edge 30d and the second hole forming edge 32d do not positively receive the tightening load. It should be noted a minute gap may be formed between the first hole forming edge 30d and one surface 46a of the resin film 46, and a minute gap may be formed between the second hole forming edge 32d and the other surface 46b of the resin film 46 so as not to receive the tightening load by the first hole forming edge 30d and the second hole forming edge 32d.

As shown in FIG. 5, in the resin film 46, the first metal separator 30, and the second metal separator 32, the oxygen-containing gas supply passage 34a, the fuel gas supply passage 38a, and the fuel gas discharge passage 38b are formed in the same manner as the oxygen-containing gas discharge passage 34b. That is, the oxygen-containing gas supply passage 34a formed in the resin film 46 is slightly smaller than the oxygen-containing gas supply passage 34a formed in the first metal separator 30 and the second metal separator 32.

The fuel gas supply passage 38a formed in the resin film 46 is slightly smaller than the fuel gas supply passage 38a formed in the first metal separator 30 and the second metal separator 32. The fuel gas discharge passage 38b formed in the resin film 46 is slightly smaller than the fuel gas discharge passage 38b formed in the first metal separator 30 and the second metal separator 32. It should be noted that the resin film 46 is held between the passage beads 52c of the first metal separator 30 and the inner bead 62b of the second metal separator 32, around the fuel gas supply passage 38a and the fuel gas discharge passage 38b.

In the resin film 46, the first metal separator 30, and the second metal separator 32, the coolant supply passage 36a and the coolant discharge passage 36b have the same size and the same shape. That is, the coolant supply passage 36a formed in the resin film 46 and the coolant supply passage 36a formed in the first metal separator 30 and the second metal separator 32 have the same size and the same shape. The coolant discharge passage 36b formed in the resin film 46 and the coolant discharge passage 36b formed in the first metal separator 30 and the second metal separator 32 have the same size and the same shape.

Operation of the fuel cell stack 10 having the above structure will be described below.

First, as shown in FIG. 1, an oxygen-containing gas is supplied to the oxygen-containing gas supply passage 34a of the end plate 20a. The fuel gas is supplied to the fuel gas supply passage 38a of the end plate 20a. The coolant is supplied to the coolant supply passage 36a of the end plate 20a.

As shown in FIG. 3, the oxygen-containing gas flows from the oxygen-containing gas supply passage 34a into the oxygen-containing gas flow field 48 of the first metal separator 30. The oxygen-containing gas flows along the oxygen-containing gas flow field 48 in the direction indicated by the arrow B, and the oxygen-containing gas is supplied to the cathode 42 of the MEA 28.

In the meanwhile, the fuel gas flows from the fuel gas supply passage 38a into the fuel gas flow field 58 of the second metal separator 32. The fuel gas flows along the fuel gas flow field 58 in the direction indicated by the arrow B, and the fuel gas is supplied to the anode 44 of the MEA 28.

Thus, in each of the MEAs 28, the oxygen-containing gas supplied to the cathode 42 and the fuel gas supplied to the anode 44 are partially consumed in electrochemical reactions in the first electrode catalyst layer 42a and the second electrode catalyst layer 44a to generate electricity. At this time, water W2 is produced as a result of power generation. This produced water W2 flows into the oxygen-containing gas discharge passage 34b through the oxygen-containing gas flow field 48 (see FIG. 6). Further, the produced water W2 may flow into the oxygen-containing gas supply passage 34a, the fuel gas supply passage 38a, and the fuel gas discharge passage 38b.

Then, the oxygen-containing gas supplied to the cathode 42 is partially consumed at the cathode 42, and then, the oxygen-containing gas is discharged along the oxygen-containing gas discharge passage 34b in the direction indicated by the arrow A. Likewise, the fuel gas supplied to the anode 44 is partially consumed at the anode 44, and then, the fuel gas is discharged along the fuel gas discharge passage 38b in the direction indicated by the arrow A.

Further, the coolant supplied to the coolant supply passage 36a flows into the coolant flow field 64 formed between the first metal separator 30 and the second metal separator 32, and then, flows in the direction indicated by the arrow B. After the coolant cools the MEA 28, the coolant is discharged from the coolant discharge passage 36b.

The fuel cell stack 10 according to the embodiment of the present invention offers the following advantages. In the following description, the oxygen-containing gas supply passage 34a, the oxygen-containing gas discharge passage 34b, the fuel gas supply passage 38a, and the fuel gas discharge passage 38b may be referred to as “reactant gas passage(s) 39”, when it is not necessary to make distinctions among these fluid passages.

In the fuel cell stack 10, the frame shaped resin film 46 is provided on the outer peripheral side of the power generation surface 41 of the MEA 28. The resin film 46 is an electrically insulating film, and has the substantially constant thickness D1. The outer peripheral end 46c of the resin film 46 protrudes outside of the first outer peripheral end 30o of the first metal separator 30 and the second outer peripheral end 32o of the second metal separator 32 over the entire periphery.

In the structure, even in the case where water condensation occurs in (electrically conductive substance is adhered to) the first outer peripheral end 30o of the first metal separator 30 and the second outer peripheral end 32o of the second metal separator 32, it is possible to prevent the first metal separator 30 and the second metal separator 32 from being connected together electrically through water droplets W1 (condensed water) or the electrically conductive substance, by the outer peripheral end 46c of the resin film 46. Therefore, it is possible to prevent corrosion of the first metal separator 30 and the second metal separator 32. The resin film 46 is held between the first outer peripheral end 30c of the first metal separator 30 and the second outer peripheral end 32c of the second metal separator 32.

In the structure, by the first outer peripheral end 30c and the second outer peripheral end 32c, it is possible to maintain the state where the outer peripheral end 46c of the resin film 46 protrudes outside of the first outer peripheral end 30o of the first metal separator 30 and the second outer peripheral end 32o of the second metal separator 32 over the entire periphery.

In the first metal separator 30, the outer bead 52a extending along, and around the first outer peripheral end 30c of the first metal separator 30 is provided for preventing leakage of fluid (the oxygen-containing gas, the fuel gas, and the coolant) to the outside through the space between the MEA 28 and the first metal separator 30. In the second metal separator 32, the outer bead 62a extending along, and around the second outer peripheral end 32c of the second metal separator 32 is provided for preventing leakage of fluid (the oxygen-containing gas, the fuel gas, and the coolant) to the outside through the space between the MEA 28 and the second metal separator 32. The resin film 46 is held between the outer bead 52a of the first metal separator 30 and the outer bead 62a of the second metal separator 32. In the structure, by the outer bead 52a of the first metal separator 30 and the outer bead 62a of the second metal separator 32, it is possible to maintain the state where the outer peripheral end 46c of the resin film 46 protrudes outside of the first outer peripheral end 30o of the first metal separator 30 and the second outer peripheral end 32o of the second metal separator 32 over the entire periphery.

The fuel cell stack 10 includes the case 13 containing the cell stack body 14, and the electrically insulating layer 19 is provided on the part of the inner surface of the case 13 (inner surface 15a of the side panel 15) which covers the outer peripheral end 46o of the resin film 46 from a direction perpendicular to the stacking direction of the cell stack body 14.

In the structure, it is possible to prevent the first metal separator 30 or the second metal separator 32 from being connected electrically to the case 13 through the water droplets W1 or the electrically conductive substance adhered to the outer peripheral end 46c of the resin film 46.

The outer peripheral end 46o of the resin film 46 is spaced from the insulating layer 19 formed on the inner surface of the case 13 (inner surface 15a of the side panel 15).

In the structure, it is possible to prevent the first metal separator 30 or the second metal separator 32 from being connected electrically to the case 13 through the water droplets W1 adhered to the outer peripheral end 46c of the resin film 46 more reliably.

The outer peripheral end 46c of the resin film 46 protrudes outside of the first metal separator 30 and the second metal separator 32 by the same first protruding length L1 in all of the power generation cells 12.

In the structure, it is possible to simplify the structure of the fuel cell stack 10.

In the fuel cell stack 10, the reactant gas passages 39 extend through the first metal separator 30, the second metal separator 32, and the resin film 46, for allowing the reactant gases (the oxygen-containing gas and the fuel gas) to flow in the stacking direction of the cell stack body 14.

The hole forming edges 46d of the resin film 46 around the reactant gas passages 39 protrude inside of the first inner ends 30i of the first hole forming edges 30d around the reactant gas passages 39 in the first metal separator 30. The hole forming edges 46d of the resin film 46 around the reactant gas passages 39 protrude inside of the second inner ends 32i of the second hole forming edges 32d around the reactant gas passages 39 in the second metal separator 32.

In the structure, even in the case where the water droplets W2 produced during power generation flow into the reactant gas passages 39, it is possible for the hole forming edges 46d of the resin film 46 to prevent the first metal separator 30 and the second metal separator 32 from being connected together electrically through the produced water W2. Therefore, it is possible to prevent corrosion of the first metal separator 30 and the second metal separator 32.

The resin film 46 is held between the first hole forming edge 30d of the first metal separator 30 and the second hole forming edge 32d of the second metal separator 32.

In the structure, by the first hole forming edge 30d and the second hole forming edge 32d, it is possible to maintain the state where the hole forming edge 46d of the resin film 46 protrudes inside of the first inner end 30i of the first hole forming edge 30d and the second inner end 32i of the second hole forming edge 32d.

The inner bead 52b and the passage beads 52c are provided in the first metal separator 30. The inner bead 62b and the passage beads 62c are provided in the second metal separator 32. The resin film 46 is held between the inner bead 52b of the first metal separator 30 and the passage beads 62c of the second metal separator 32. Further, the resin film 46 is held between the passage beads 52c of the first metal separator 30 and the inner bead 62b of the second metal separator 32.

In the structure, by the inner beads 52b, 62b and the passage beads 52c, 62c, it is possible to maintain the state where the hole forming edges 46d of the resin film 46 protrude inside of the first inner end 30i of the first hole forming edge 30d and the second inner end 32i of the second hole forming edge 32d more reliably.

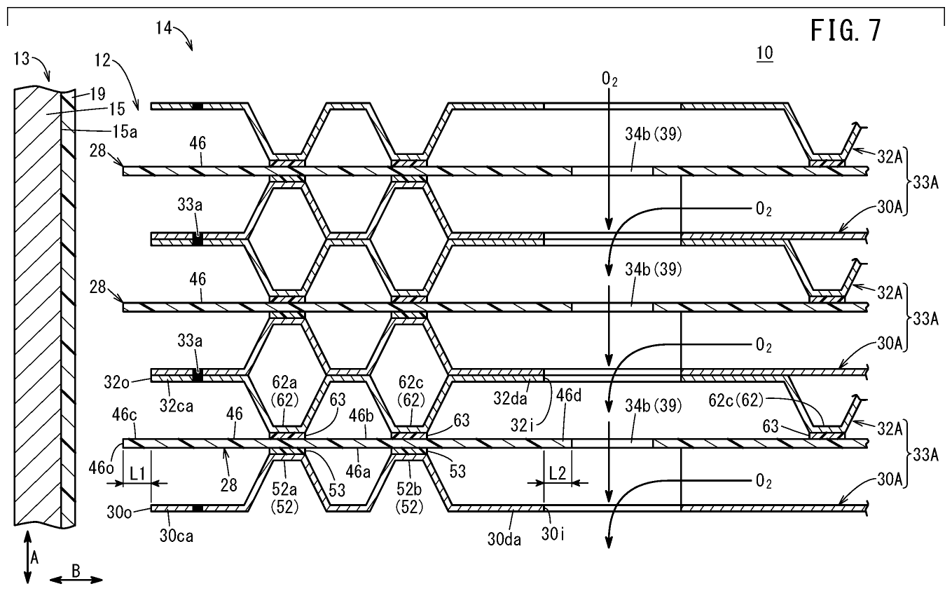

Next, a first metal separator 30A and a second metal separator 32A according to a modified embodiment will be described with reference to FIG. 7. As shown in FIG. 7, a first outer peripheral end 30ca of the first metal separator 30A extends outward from a root of the outer bead 52a to the first outer peripheral end 30o of the first metal separator 30A in the direction indicated by the arrow B. That is, the first outer peripheral end 30ca is spaced from one surface 46a of the resin film 46.

A second outer peripheral end 32ca of the second metal separator 32A extends outward from a root of the outer bead 62a to the second outer peripheral end 32o of the second metal separator 32A in the direction indicated by the arrow B. The second outer peripheral end 32ca is spaced from the other surface 46b of the resin film 46. The first outer peripheral end 30ca of the first metal separator 30A and the second outer peripheral end 32ca of the second metal separator 32A are joined together by the joint bead 33a (welding bead) to form a joint separator 33A.

A first hole forming edge 30da of the first metal separator 30A extends from the root of the inner bead 52b in the direction indicated by the arrow B. That is, the first hole forming edge 30da is spaced from one surface 46a of the resin film 46. A second hole forming edge 32da of the second metal separator 32A extends from the root of the passage bead 62c in the direction indicated by the arrow B. That is, the second hole forming edge 32da is spaced from the other surface 46b of the resin film 46.

In the modified embodiment, it is possible to suppress application of the tightening load to the first outer peripheral end 30ca, the second outer peripheral end 32ca, the first hole forming edge 30da, and the second hole forming edge 32da. Therefore, since the tightening load in the stacking direction can be applied to the first seal bead 52 and the second seal bead 62 effectively, it is possible to achieve the desired seal performance of the first seal bead 52 and the second seal bead 62.

The present invention is not limited to the above described embodiments. Various modifications can be made without departing from the gist of the present invention.

The above embodiments are summarized as follows:

The above embodiments disclose the fuel cell stack (10) including the cell stack body (14) including the plurality of stacked power generation cells (12), the power generation cells (12) each including the membrane electrode assembly (28) and the pair of metal separators (30, 32) provided on both sides of the membrane electrode assembly (28), the membrane electrode assembly (28) including the electrolyte membrane (40), and the electrodes (42, 44) provided on both sides of the electrolyte membrane (40), wherein the electrically insulating frame shaped outer film (46) having the substantially constant thickness (D1) is provided on the outer peripheral side of the power generation surface (41) of the membrane electrode assembly, and the outer peripheral end (46c) of the outer film protrudes outside of the outer peripheral ends (30o, 32o) of the pair of metal separators over the entire periphery.

In the fuel cell stack, the outer film may be held between the outer peripheral ends (30c, 32c) of the pair of metal separators.

In the fuel cell stack, each of the pair of metal separators may be provided with the outer bead (52a, 62a) extending along, and around the outer peripheral end of each of the pair of metal separators and configured to prevent leakage of fluid to the outside from the space between each of the pair of metal separators and the membrane electrode assembly, and the outer film may be held between the outer beads of the pair of metal separators.

The fuel cell stack may further include the case (13) containing the cell stack body, and the electrically insulating layer (19) may be provided in the part (15a) of the inner surface of the case which covers the outer peripheral end (46o) of the outer film in the direction perpendicular to the stacking direction of the cell stack body.

In the above fuel cell stack, the outer peripheral end of the outer film may be spaced from the insulating layer. In the fuel cell stack, in all of the power generation cells, the outer peripheral end of the outer film may protrude outward from the pair of metal separators by the same protruding length (L1).

The above embodiments disclose the fuel cell stack including the cell stack body including the plurality of stacked power generation cells, the power generation cells each including the membrane electrode assembly and the pair of metal separators provided on both sides of the membrane electrode assembly, the membrane electrode assembly including the electrolyte membrane, and the electrodes provided on both sides of the electrolyte membrane, wherein the electrically insulating frame shaped outer film having the substantially constant thickness is provided on the outer peripheral side of the power generation surface of the membrane electrode assembly, and the reactant gas passage (39) is formed in each of the pair of metal separators and the outer film, for allowing the reactant gas to flow in the stacking direction of the cell stack body, and the hole forming edge (46d) of the outer film around the reactant gas passage protrudes inside of inner ends (30i, 32i) of hole forming edges (30d, 32d) of the pair of metal separators around the reactant gas passage.

In the fuel cell stack, the outer film may be held between the hole forming edges of the pair of metal separators around the reactant gas passage.

In the fuel cell stack, each of the pair of the metal separators may be provided with the bead (52b, 52c, 62b, 62c) extending along the reactant gas passage and configured to prevent leakage of the reactant gas to the outside from the reactant gas passage, and the outer film may be held between the beads of the pair of metal separators.

What is claimed is:

1. A fuel cell stack comprising a cell stack body including a plurality of stacked power generation cells, the power generation cells each including a membrane electrode assembly and a pair of metal separators provided on both sides of the membrane electrode assembly, the membrane electrode assembly including an electrolyte membrane, and electrodes provided on both sides of the electrolyte membrane,
wherein an electrically insulating frame shaped outer film having a substantially constant thickness is provided on an outer peripheral side of a power generation surface of the membrane electrode assembly; and
an outer peripheral end of the outer film protrudes outside of outer peripheral ends of the pair of metal separators over entire periphery.

2. The fuel cell stack according to claim 1, wherein the outer film is held between the outer peripheral ends of the pair of metal separators.

3. The fuel cell stack according to claim 1, wherein each of the pair of metal separators is provided with an outer bead extending along, and around an outer peripheral end of each of the pair of metal separators, and configured to prevent leakage of fluid to outside from a space between each of the pair of metal separators and the membrane electrode assembly; and
the outer film is held between the outer beads of the pair of metal separators.

4. The fuel cell stack according to claim 1, further comprising a case containing the cell stack body,
wherein an electrically insulating layer is provided in a part of an inner surface of the case which covers an outer peripheral end of the outer film in a direction perpendicular to a stacking direction of the cell stack body.

5. The fuel cell stack according to claim 4, wherein the outer peripheral end of the outer film is spaced from the insulating layer.

6. The fuel cell stack according to claim 1, wherein in all of the power generation cells, the outer peripheral end of the outer film protrudes outward from the pair of metal separators by same protruding length.

7. A fuel cell stack comprising a cell stack body including a plurality of stacked power generation cells, the power generation cells each including a membrane electrode assembly and a pair of metal separators provided on both sides of the membrane electrode assembly, the membrane electrode assembly including an electrolyte membrane, and electrodes provided on both sides of the electrolyte membrane,
wherein an electrically insulating frame shaped outer film having a substantially constant thickness is provided on an outer peripheral side of a power generation surface of the membrane electrode assembly; and
a reactant gas passage is formed in each of the pair of metal separators and the outer film, for allowing a reactant gas to flow in a stacking direction of the cell stack body; and
a hole forming edge of the outer film around the reactant gas passage protrudes inside of inner ends of hole forming edges of the pair of metal separators around the reactant gas passage.

8. The fuel cell stack according to claim 7, wherein the outer film is held between the hole forming edges of the pair of metal separators around the reactant gas passage.

9. The fuel cell stack according to claim 7, wherein each of the pair of the metal separators is provided with a bead extending along the reactant gas passage and configured to prevent leakage of a reactant gas to the outside from the reactant gas passage; and
the outer film is held between the beads of the pair of metal separators.
